(19) United States
(12) Patent Application Publication
(10) Pub. No.: US 2010/0059344 A1
(43) Pub. Date: Mar. 11, 2010

(54) LIQUID LEVEL SENSOR

(76) Inventors: Ken Belanger, St. Clair Shores, MI (US); Darren Johnson, Romulus, MI (US); Hans Jensen, West Bloomfield, MI (US); Zhouxuan Xia, Windsor (CA)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/207,934

(22) Filed: Sep. 10, 2008

(51) Int. Cl. H01H 35/18

(52) U.S. Cl. 200/61.2

(57) ABSTRACT

A vessel for accumulating water removed from a hydrocarbon fuel supply is disclosed. The vessel may include a base member and a cover cooperating with the base member to define a reservoir for receiving a liquid. The cover defines a pocket that may be integrally formed with the cover, the pocket generally preventing intrusion of the liquid in the reservoir. The vessel further includes a liquid level sensor, including a switch received in the pocket, and an actuator configured to activate the switch when the fluid within the reservoir reaches a predetermined level.

### BACKGROUND

Water may naturally accumulate in hydrocarbon fuels through a number of known mechanisms. For example, water vapor may condense in fuel stored in a closed tank or vessel for an extended period of time. Water may also accumulate in hydrocarbon fuels during transportation from refineries to service stations. The accumulation of water in a hydrocarbon fuel is problematic for internal combustion engines, and especially diesel engines, as it may cause corrosion and/or growth of microorganisms that can damage engine components.

Various methods have been developed for removing accumulated water from hydrocarbon fuels. However, water collected from hydrocarbon fuels typically must be stored on board a vehicle until the water can be removed. If water is not removed regularly, water removal systems can become backlogged, inhibiting further collection of accumulated water from the fuel system.

Sensors may be provided in a reservoir that notify a vehicle operator when the reservoir is full. However, such systems generally add complexity to the reservoir that increases assembly and service/replacement costs of the water removal system. For example, the sensors are generally required to be mounted on a bottom portion of a reservoir in order to accurately determine an amount of water contained within the reservoir. Assembly of sensors to a bottom portion of the reservoir is generally inconvenient, as assembly operators must reach underneath an installed reservoir to make the connections necessary to allow the sensors to communicate with a display that notifies a vehicle operator that the reservoir is full.

Accordingly, there is a need for a reservoir for accumulating water removed from a hydrocarbon fuel supply that allows for monitoring an amount of water accumulated within the reservoir, and yet is relatively simple to assemble and install in a vehicle.

### SUMMARY

Various exemplary illustrations of a vessel or tank for accumulating water removed from a hydrocarbon fuel supply are disclosed herein. According to one exemplary illustration, a vessel may include a base member and a cover cooperating with the base member to define a reservoir for receiving a liquid. The cover defines a pocket that may be integrally formed with the cover, the pocket generally preventing ingress of the liquid in the reservoir. The vessel further includes a liquid level sensor, including a switch received in the pocket, and an actuator configured to activate the switch when the fluid within the reservoir reaches a predetermined level.

Another exemplary illustration of a vessel includes a base member and a cover cooperating with the base member to define a reservoir for receiving a liquid. The cover may include a housing and a pocket disposed outside the reservoir that is configured to generally prevent intrusion of liquid contained in the reservoir. The vessel further includes a liquid level sensor, including a switch received in the pocket, and an actuator configured to activate the switch when the fluid within the reservoir reaches a predetermined level.

### BRIEF DESCRIPTION OF THE DRAWINGS

While the claims are not limited to the illustrated embodiments, an appreciation of various aspects is best gained through a discussion of various examples thereof. Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description. Exemplary embodiments of the present invention are described in detail by referring to the drawings as follows.

FIG. 1A is a cutaway perspective view of a first example of a vessel;

FIG. 1B is a bottom perspective view of a cover for the first example of a vessel;

FIG. 2 is a section view of the first example of a vessel;

FIG. 3 is a perspective view of a second example of a vessel;

FIG. 4 is a bottom perspective view of the second example of a cover for a vessel;

FIG. 5A is a partial cutaway view of the cover of FIG. 4, taken along lines 5A-5A; and

FIG. 5B is a partial cutaway view of the cover of FIG. 4, taken along lines 5B-5B.

### DETAILED DESCRIPTION

Reference in the specification to “an exemplary illustration”, and “example” or similar language means that a particular feature, structure, or characteristic described in connection with the exemplary approach is included in at least one illustration. The appearances of the phrase “in an illustration” or similar type language in various places in the specification are not necessarily all referring to the same illustration or example.

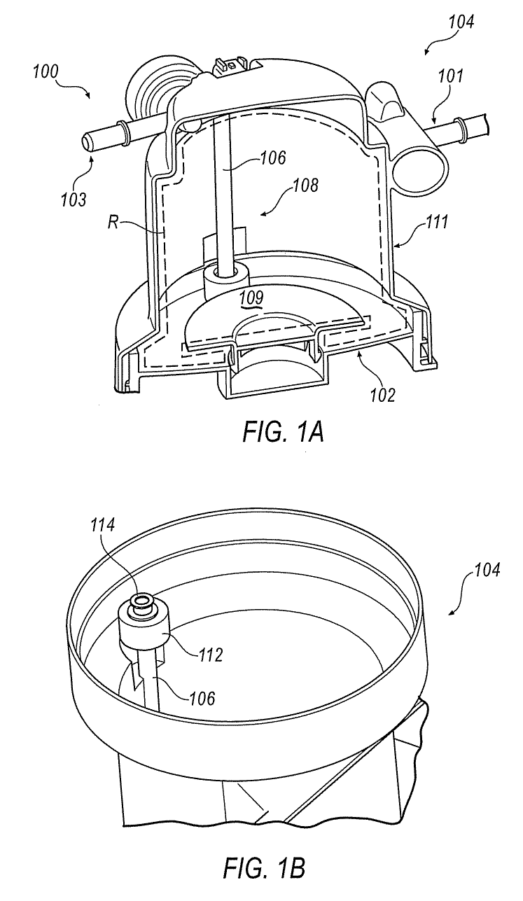

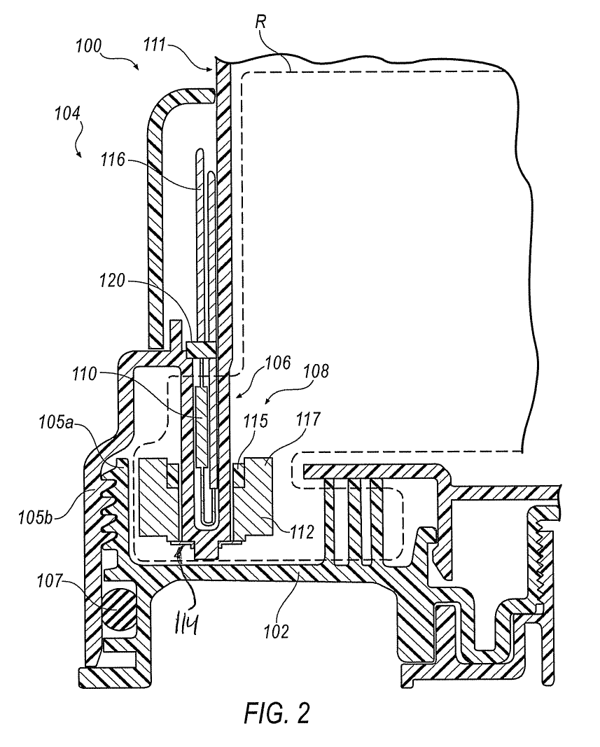

Turning now to FIGS. 1A, 1B, and 2, a vessel or tank 100 is shown. Vessel 100 may be a hydrocarbon fuel conditioning module configured to accumulate water that is removed from a hydrocarbon fuel supply, e.g., a diesel fuel supply. For example, vessel 100 may include an inlet 101 and an outlet 103 for receiving and expelling a fuel supply, respectively. Further, vessel 100 is configured to remove or filter water from the incoming fuel supply, thereby accumulating water within vessel 100, e.g., within reservoir R (indicated by dashed lines) of the vessel 100. Vessel 100 may employ any known mechanism for filtering or separating water from an incoming fuel supply (not shown). For example, vessel 100 may employ a hydrophobic media (not shown), which generally screens water molecules and/or contaminants contained within a hydrocarbon fuel. The hydrophobic media may be placed transverse to a fuel flow, such that fuel flows through the hydrophobic media while water molecules are retained by the hydrophobic media. The screened water may then descend and accumulate in the bottom of reservoir R for removal, as a result of gravity, as water generally has a greater density than hydrocarbon fuels. Other contaminants may also be screened from the fuel flow, and descend toward the bottom of reservoir R. In other words, water and other contaminants may generally be collected in a bottom portion of vessel 100. Further, vessel 100 may include any other known devices for collecting water contained in a hydrocarbon fuel. Vessel 100 may further include a heating element 109. Heating element 109 is generally operable to supply heat to accumulated water and/or contaminants removed from the fuel to prevent freezing or hardening of the contaminants removed that are contained within reservoir R. While a heating element 109 is shown, other heating mechanisms may also be used, such as application of waste heat from a vehicle operation (e.g., from combustion of the hydrocarbon fuel). Heating element 109 may also generally heat fuel to prevent undesirable changes in composition that may be caused by exposure to extremely cold temperatures. Vessel 100 may also include a drain (not shown) for exhausting water filtered from a fuel supply. A drain may be advantageously located at or near a bottom surface of vessel 100, such that gravity promotes the flow of water out of vessel 100 when the drain is opened, and further, water removed from the fuel supply will tend to accumulate near the drain.

Vessel 100 includes a base member 102 and a cover 104. Base member 102 and cover 104 may be formed by any known plastic forming processes, e.g., molded or blow molded from a plastic material. For example, in one example, base member 102 and cover 104 are formed from PA66, a polyamide nylon material. Base member 102 and cover 104 cooperate to generally define reservoir R of vessel 100. In other words, base member 102 and cover 104 cooperate to define a generally enclosed volume that accumulates water removed from the diesel fuel supply. Base member 102 and cover 104 are secured together, and may define complementary threads 105a, 105b, respectively as shown in FIG. 2. Complementary threads 105a, 105b of base member 102 and cover 104 may allow installation and assembly of vessel 100 from a top side of base member 102. For example, base member 102 is configured to be installed into a vehicle at a desired mounting location for vessel 100. Base member 102 may be positioned within and secured to a vehicle, e.g., with one or more mechanical fasteners (not shown), by bonding, or the like. Cover 104 may then be assembled to base member 102 by generally turning cover 104 as it is placed against a top side of base member 102, thereby engaging complementary threads 105a, 105b, and generally enclosing reservoir R. Additionally, base member 102 and/or cover 104 may include a seal 107 that generally prevents water contained within vessel 100 from escaping volume R.

As best shown in FIG. 2, cover 104 may include a housing 111 that defines a pocket 106. Pocket 106 receives a liquid level sensor assembly 108 configured to detect an amount of water contained within vessel 100, e.g., within reservoir R. For example, as shown in FIGS. 1A, 1B, and 2, housing 111 may generally define a pocket 106 that extends into reservoir R. Accordingly, pocket 106 may be integrally formed in housing 111 and/or cover 104. As shown in FIG. 2, pocket 106 may generally extend into reservoir R, thereby allowing liquid level sensor 108 to determine an amount of water contained within reservoir R. Pocket 106 is generally insulated from reservoir R or at least prevents intrusion of liquids contained within reservoir R into pocket 106. Further, as shown in FIG. 2, pocket 106 includes a plug 120 that generally prevents intrusion of external contaminants, thereby protecting liquid level sensor 108 from fouling or damage. Pocket 106 may additionally include a compound that generally fills the pocket 106, thereby securing the liquid level sensor 108, and in particular generally surrounding a switch 110 of liquid level sensor 108, from damage due to vibration, shock, external contaminants, etc.

Liquid level sensor 108 may generally include a switch 110, and an actuator 112. As shown in FIG. 2, switch 110 is generally disposed within pocket 106. Actuator 112 is generally configured to activate switch 110 according to a level of fluid within reservoir R. In other words, actuator 112 is responsive to changes in the level of fluid within reservoir R. For example, as shown in FIG. 2, actuator 112 may include a magnet 115, and a float 117 retained about pocket 106 with a push nut 114. Float 117 may be formed of a buoyant material, and is configured to rise with the level of water contained within reservoir R. Magnet 115 may be any magnetic material or other device configured to induce a magnetic field about switch 110 when float 117 rises sufficiently to place magnet 115 adjacent switch 110. Accordingly, actuator 112 is disposed about pocket 106, and is configured to translate along pocket 106 in response to a change in the amount of liquid contained within reservoir R. When actuator 112 rises to a predetermined level, switch 110 may open or close in response to the inducement of an electromagnetic field by actuator 112, thereby providing a signal to indicate that the liquid level within reservoir R has reached the predetermined level.

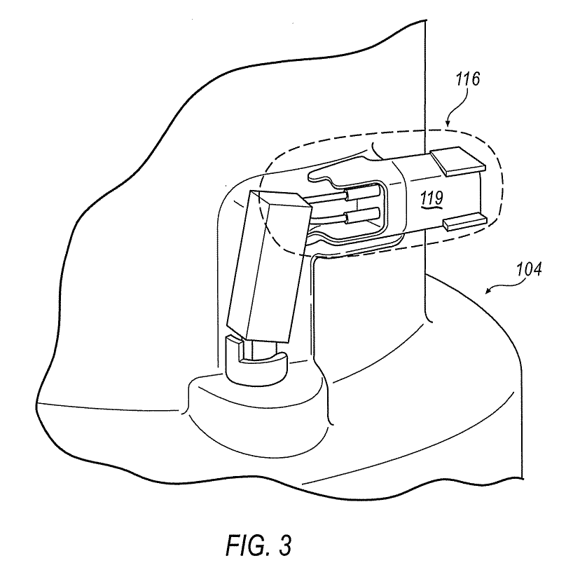

Switch 110 may include one or more electrical contacts 116 that allow electrical communication between switch 110 and, for example, a display (not shown) that indicates that the water level within reservoir R has reached a predetermined level to a vehicle operator. Electrical contacts 116 are advantageously provided on a top side of base member 102. In other words, after cover 104 is assembled to base member 102 from a generally top side of base member 102, electrical contacts 116 may be connected with wiring on the same side of base member 102, i.e., the top side of base member 102. The provision of electrical contacts 116 on the same top side of base member 102 thereby simplifies assembly of vessel 100, as the electrical connections for vessel 100 are easily accessible to an assembly operator. Further, the cover 104 may be removed from the base member 102 without removing electrical contacts 116 from the cover 104. As shown in FIG. 3, electrical contacts 116 may be provided with a snap-fit connector 119 as shown, a cover, or otherwise protected from external contaminants.

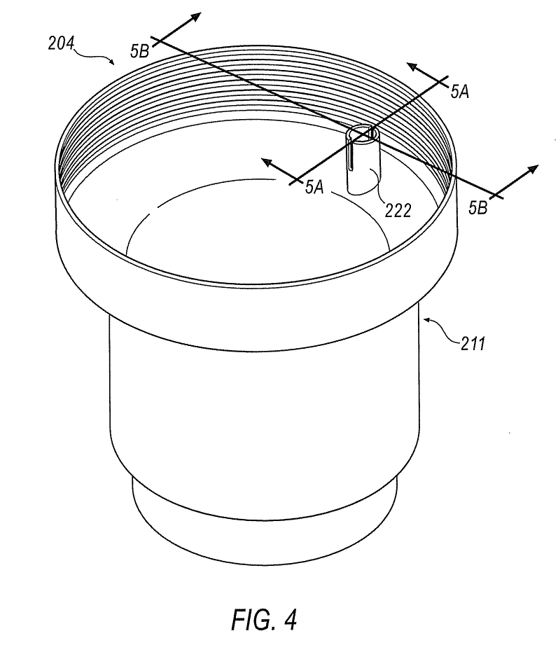

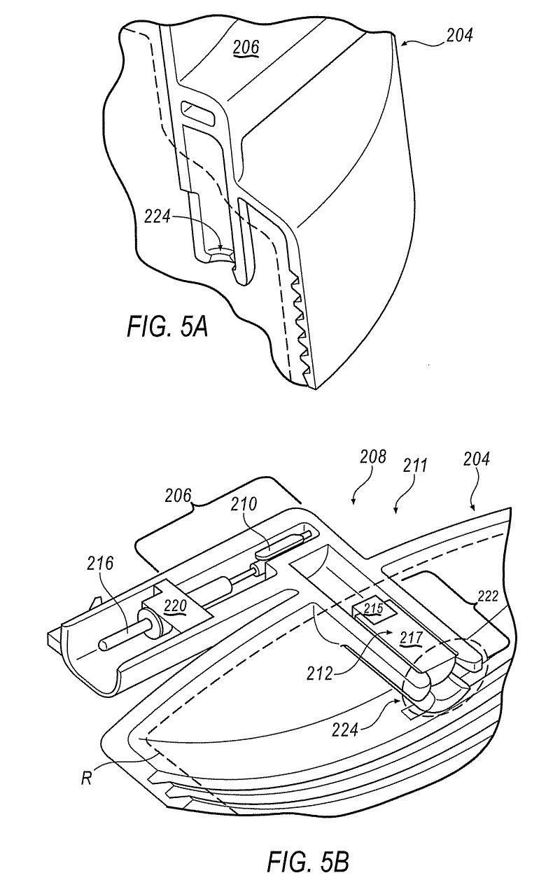

Turning now to FIGS. 4-5, another exemplary cover 204 is illustrated. As with cover 104 described above, cover 204 may cooperate with a base member (not shown) to define a reservoir R of a vessel or tank, e.g., of a fuel conditioning module. For example, cover 204 may also include complementary threading allowing assembly from a top side of a base member.

As best seen in FIG. 5B, cover 204 includes a main housing 211 and a pocket 206 that extends from an external surface of main housing 211. Pocket 206 may be defined by cover 204 or may be integrally formed within cover 204. Pocket 206 is preferably insulated from reservoir R to prevent intrusion of liquid contained within the reservoir R. Pocket 206 may further include a plug 220 to prevent intrusion of external contaminants. Pocket 206 may be disposed outside of reservoir R. Accordingly, pocket 206 is formed on an outer surface of housing 211 and generally does not protrude into reservoir R of the vessel.

Cover 204 further includes a liquid level sensor 208, including switch 210 and actuator 212. Switch 210 is generally disposed within pocket 206. For example, as generally similar to switch 110 described above, switch 210 may be a reed switch or other switch configured to respond to the inducement of an electromagnetic field. Actuator 212 is generally configured to activate switch 210 according to changes in a level of fluid contained within reservoir R. For example, actuator 212 may generally open or close switch 210 when fluid reaches a predetermined level, thereby moving actuator 212 in close proximity to switch 210. Actuator 212 may include a magnet 215 and a float 217. Actuator 212 is generally retained within a cavity 222 that is in operational communication with liquid contained within reservoir R. In other words, actuator 212 is generally responsive to changes in the liquid level contained within reservoir R. For example, float 217 may be formed of a buoyant material, generally rising or falling with the level of water contained within reservoir R. As actuator 212 rises within cavity 222, magnet 215 is brought in proximity to switch 110, thereby inducing a magnetic field about switch 210 that may open or close switch 210, initiating an electrical signal at electrical contacts 216. Cavity 222 may be provided with an undercut lip 224, as best seen in FIG. 5A, that generally retains actuator 212 within cavity 222. Further, an undercut lip 224 may allow for insertion of actuator 212 into cavity 222 during assembly, while still securing actuator 212 within cavity 222 upon insertion, thereby generally simplifying assembly of the cover 204. For example, as shown in FIG. 5A, undercut lip 224 has an angled or sloped side that cooperates with notches provided in the sides of cavity 222 to allow the actuator 212 to generally push the sides of cavity 22 outwards as the actuator 212 is inserted into cavity 222. After insertion of actuator 212 into cavity 222, undercut lip 224 generally prevent egress of actuator 212 from the cavity 222.

As briefly described above, cover 204 includes one or more electrical contacts 216 that are in electrical communication with switch 210. Electrical contacts 216 may be provided on a generally top side of cover 204, such that any wiring assemblies or connectors (not shown) used to connect switch 210 to a display (not shown) may be secured to electrical contact 216 on the top side of cover 204. Further, cover 204 may be assembled to a base member (not shown) that is secured to a vehicle from a top side of the base member (not shown), similar to cover 104 described above. Accordingly, cover 204 may be assembled from a same side of the base member as that from which the electrical connection 216 is provided. Accordingly, assembly of a tank or vessel employing a cover 204 is relatively simple, as an assembly operator need not reach around the base member to make the electrical connections for the vessel.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain approaches, examples or embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A vessel, comprising:
a base member;
a cover cooperating with said base member to define a reservoir for receiving a liquid, said cover defining a pocket integrally formed with said cover, said pocket generally preventing ingress of the liquid in the reservoir; and
a liquid level sensor, including:
a switch received in said pocket; and
an actuator configured to activate said switch when the fluid within said reservoir reaches a predetermined level.

2. The vessel of claim 1, wherein said cover is disposed on a top side of said base member, and includes an electrical connection for said switch adjacent said pocket, said electrical connection accessible from a same side of said base member as said cover.

3. The vessel of claim 1, wherein said pocket protrudes into said reservoir.

4. The vessel of claim 3, wherein said actuator is disposed about said pocket, and is configured to translate along said pocket in response to a change in the amount of liquid contained within the reservoir.

5. The vessel of claim 1, wherein said pocket is disposed outside said reservoir.

6. The vessel of claim 5, wherein said actuator is disposed within said reservoir.

7. The vessel of claim 5, wherein said actuator is disposed within a cavity defined by said cover, said cavity in operational communication with the liquid inside the reservoir.

8. The vessel of claim 1, wherein said actuator includes a magnet, and said switch is responsive to a field induced by said magnet.

9. The vessel of claim 1, further comprising a plug configured to generally prevent intrusion of an external contaminant into said pocket.

10. A vessel, comprising:
a base member;
a cover cooperating with said base member to define a reservoir for receiving a liquid, said cover including a pocket disposed outside said reservoir, said pocket configured to generally prevent intrusion of liquid in the reservoir; and
a liquid level sensor, including:
a switch received in said pocket; and
an actuator configured to activate said switch when the fluid within said reservoir reaches a predetermined level.

11. The vessel of claim 10, wherein said actuator is disposed within said reservoir.

12. The vessel of claim 11, wherein said actuator is disposed within a cavity defined by said cover, said cavity in operational communication with the liquid inside the reservoir.

13. The vessel of claim 10, wherein said cover includes an electrical connection for said switch adjacent said pocket, said electrical connection allowing electrical communication between said switch and a display configured to indicate when the liquid reaches said predetermined level.

14. The vessel of claim 10, wherein said pocket is integrally formed with said cover.

15. The vessel of claim 10, wherein said actuator includes a magnet, and said switch is responsive to a field induced by said magnet.

16. The vessel of claim 10, further comprising a plug configured to generally prevent intrusion of an external contaminant into said pocket.

17. A cover for a vessel, comprising:
a housing configured to cooperate with a base member to define a reservoir for receiving a liquid, said housing defining a pocket disposed outside said reservoir, said pocket configured to generally prevent intrusion of liquid in the reservoir; and
a liquid level sensor, including:
a switch received in said pocket; and
an actuator configured to activate said switch when the fluid within said reservoir reaches a predetermined level.

18. The cover of claim 17, wherein said actuator is disposed within said reservoir.

19. The cover of claim 18, wherein said actuator is disposed within a cavity defined by said cover, said cavity in operational communication with the liquid inside the reservoir.

20. The cover of claim 17, wherein said cover includes an electrical connection for said switch adjacent said pocket, said electrical connection allowing electrical communication between said switch and a display configured to indicate when the liquid reaches said predetermined level.
